(19) United States
(12) Patent Application Publication
(10) Pub. No.: US 2026/0051468 A1
(43) Pub. Date: Feb. 19, 2026

(54) MULTIPOLE ION GUIDE INCLUDING GROUPED BLADES

(71) Applicant: AGILENT TECHNOLOGIES, INC., Santa Clara, CA (US)

(72) Inventor: Tong CHEN, Santa Clara, CA (US)

(73) Assignee: AGILENT TECHNOLOGIES, INC., Santa Clara, CA (US)

(21) Appl. No.: 19/226,364

(22) Filed: Jun. 3, 2025

Related U.S. Application Data
(60) Provisional application No. 63/683,511, filed on Aug. 15, 2024.

(51) Int. Cl. H01J 49/06

(52) U.S. Cl. CPC H01J 49/063; H01J 49/065

(57) ABSTRACT

In some examples, a multipole ion guide may include a plurality of electrode groups that are arranged circumferentially around an axis of the multipole ion guide. At least one electrode group of the plurality of electrode groups may include at least three electrodes that are disposed in a side-by-side configuration.

### CROSS-REFERENCE TO RELATED APPLICATION(S)

This application claims priority to U.S. Provisional Patent Application Ser. No. 63/683,511, filed Aug. 15, 2024, titled “MULTIPOLE ION GUIDE INCLUDING GROUPED BLADES”, which is incorporated by reference in its entirety.

### BACKGROUND

A Quadrupole-Time-of-Flight (QTOF) mass spectrometer may generally include a quadrupole mass analyzer to select ions of desired mass-to-charge ratio and a collision cell to fragment the selected ions via collision-induced dissociation. The QTOF mass spectrometer may further include a series of ion lenses to transfer the ions downstream to a TOF mass analyzer that differentiates ions by the mass-to-charge ratio. An ion guide inside the collision cell may compress an ion beam to reduce beam diameter and kinetic energy via collisional cooling. This reduction in the beam diameter and kinetic energy may thus generate an ion beam that is well-conditioned at an exit as required by downstream optics for achieving desired resolution and sensitivity.

### BRIEF DESCRIPTION OF DRAWINGS

Features of the present disclosure are illustrated by way of example and not limited in the following figure(s), in which like numerals indicate like elements, in which:

FIG. 1 illustrates a multipole ion guide including grouped blades (hereinafter “multipole ion guide”), where the multipole ion guide is shown as including an even number of electrode groups that are arranged circumferentially around an axis, in accordance with an example of the present disclosure;

FIG. 2A illustrates a cross-section of the multipole ion guide of FIG. 1 at the entrance, in accordance with an example of the present disclosure;

FIG. 2B illustrates a cross-section of the multipole ion guide of FIG. 1 at the exit, in accordance with an example of the present disclosure;

FIG. 3 illustrates a side view of the three blade electrodes of each group for the multipole ion guide of FIG. 1, in accordance with an example of the present disclosure;

FIG. 4 illustrates a hollow middle electrode to reduce electrical capacitance to side electrodes for the multipole ion guide of FIG. 1, in accordance with an example of the present disclosure;

FIG. 5 illustrates how the side electrodes may be divided into two sections in an axial dimension and tapered in opposite directions in the axial dimension for the multipole ion guide of FIG. 1, in accordance with an example of the present disclosure;

FIG. 6 illustrates a hexapole configuration for the multipole ion guide of FIG. 1, in accordance with an example of the present disclosure;

FIG. 7 illustrates an operational scheme where a middle electrode in each group is supplied with a different DC voltage than side electrodes for the multipole ion guide of FIG. 1, in accordance with an example of the present disclosure;

FIG. 8 illustrates an operational scheme where AC voltages on side electrodes of adjacent groups are of a same frequency and amplitude, and of same phases for the multipole ion guide of FIG. 1, in accordance with an example of the present disclosure;

FIG. 9 illustrates an operational scheme where AC voltages on side electrodes of adjacent groups are of a same frequency and amplitude, and of opposite phases for the multipole ion guide of FIG. 1, in accordance with an example of the present disclosure; and

FIG. 10 illustrates an operational scheme where AC voltages are supplied to middle and side electrodes for the operational schemes of FIGS. 7-9, for the multipole ion guide of FIG. 1, in accordance with an example of the present disclosure.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

A multipole ion guide including grouped blades (hereinafter “multipole ion guide”) is disclosed herein. The multipole Ion guide may include a plurality of electrode groups to construct the multipole ion guide. Each electrode group may include three blade electrodes that are tapered differently in width and are attached together side-by-side but electrically isolated from each other.

For the multipole ion guide disclosed herein, the effective width of the multipole may be varied with an inscribed radius along an axis, which increases the acceptance at the entrance and preserves the focusing power at the exit.

According to examples disclosed herein, the multipole ion guide disclosed herein provides for improved surface finishing, and thus the reliability of the multipole ion guide.

According to examples disclosed herein, the multipole ion guide disclosed herein provides for reduced risks of heat dissipation and high voltage creepage.

According to examples disclosed herein, the multipole ion guide disclosed herein provides for additional multipole fields that may be superimposed as disclosed herein.

According to examples disclosed herein, the multipole ion guide provides for an additional longitudinal pseudo-potential well that may be superimposed to provide the additional functionality of an ion trap.

According to examples disclosed herein, a multipole ion guide may include a plurality of electrode groups that are arranged circumferentially around an axis of the multipole ion guide. At least one electrode group of the plurality of electrode groups may include at least three electrodes that are disposed in a side-by-side configuration.

According to examples of the multipole ion guide disclosed herein, the plurality of electrode groups may include an even number of electrode groups.

According to examples of the multipole ion guide disclosed herein, the at least three electrodes may include blade electrodes that are electrically isolated from each other. The at least three electrodes may be electrically isolated from each other by at least one of dielectric spacing or a flex circuit.

According to examples of the multipole ion guide disclosed herein, the at least three electrodes may be tapered in a widthwise dimension to include a larger width at an entrance of the multipole ion guide to a smaller width at an exit of the multipole ion guide.

According to examples of the multipole ion guide disclosed herein, side electrodes of the at least three electrodes may be tapered in a widthwise dimension to include a larger width at an entrance of the multipole ion guide to a smaller width at an exit of the multipole ion guide. In this regard, an inner electrode of the at least three electrodes may be tapered in a widthwise dimension to include a smaller width at the entrance of the multipole ion guide to a larger width at the exit of the multipole ion guide.

According to examples of the multipole ion guide disclosed herein, the at least three electrodes may be linearly tapered in a widthwise dimension.

According to examples of the multipole ion guide disclosed herein, a thickness of a middle electrode of the at least three electrodes may be different from a thickness of side electrodes of the at least three electrodes.

According to examples of the multipole ion guide disclosed herein, a middle electrode of the at least three electrodes may include a hollow configuration compared to side electrodes of the at least three electrodes.

According to examples of the multipole ion guide disclosed herein, side electrodes of the at least three electrodes may be divided in two sections along an axial dimension of the multipole ion guide. Each section of the two sections may be tapered in opposite directions along the axial dimension for the multipole ion guide.

According to examples disclosed herein, a method of operating the multipole ion guide disclosed herein may include applying a different direct current (DC) voltage to a middle electrode of the at least three electrodes compared to side electrodes of the at least three electrodes.

According to examples disclosed herein, a method of operating the multipole ion guide disclosed herein may include applying a different alternating current (AC) voltage phase to an electrode group of the plurality of electrode groups compared to an adjacent electrode group of the plurality of electrode groups.

According to examples disclosed herein, a method of operating the multipole ion guide disclosed herein may include applying a different alternating current (AC) voltage to a middle electrode of the at least three electrodes compared to side electrodes of the at least three electrodes.

According to examples disclosed herein, a method of operating the multipole ion guide disclosed herein may include applying a different alternating current (AC) voltage phase to a front section of a side electrode of the at least three electrodes compared to a back section of the side electrode of the at least three electrodes.

According to examples disclosed herein, a method of operating the multipole ion guide disclosed herein may include applying a different direct current (DC) voltage to a front section of a side electrode of the at least three electrodes compared to a back section of the side electrode of the at least three electrode, and applying a further different DC voltage to a middle electrode of the at least three electrodes.

According to examples disclosed herein, a multipole ion guide may include a plurality of electrode groups that are arranged circumferentially around an axis of the multipole ion guide. Each electrode group of the plurality of electrode groups may include at least three electrodes that are disposed in a side-by-side configuration.

According to examples disclosed herein, a multipole ion guide may include a plurality of electrode groups that are arranged around an axis of the multipole ion guide. Each electrode group of the plurality of electrode groups may include at least three electrodes that are disposed in a side-by-side configuration.

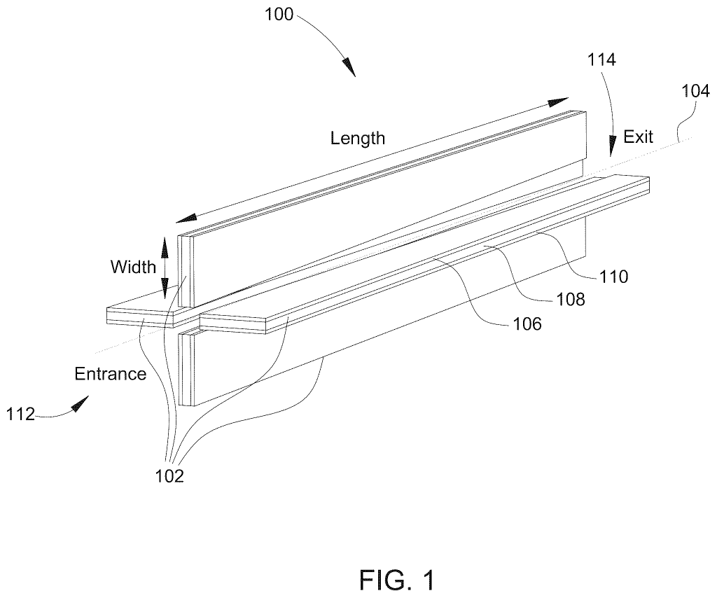

FIG. 1 illustrates a multipole ion guide including grouped blades (hereinafter “multipole ion guide 100”), where the multipole ion guide 100 is shown as including an even number of electrode groups that are arranged circumferentially around an axis, in accordance with an example of the present disclosure.

Referring to FIG. 1, the multipole ion guide 100 is shown as including an even number of electrode groups 102 that are arranged circumferentially around an axis 104. In the example of FIG. 1, a number of the electrode groups 102 is greater than or equal to four. Each electrode group may include three blade electrodes 106, 108, and 110 that are attached together side-by-side, but electrically isolated from each other. The blade electrodes may be oriented radially with a width measured in a radial dimension and a length measured in an axial dimension of the axis 104. In one example, the blade electrodes may be tapered in the widthwise dimension from a larger width at entrance 112, to a smaller width at exit 114.

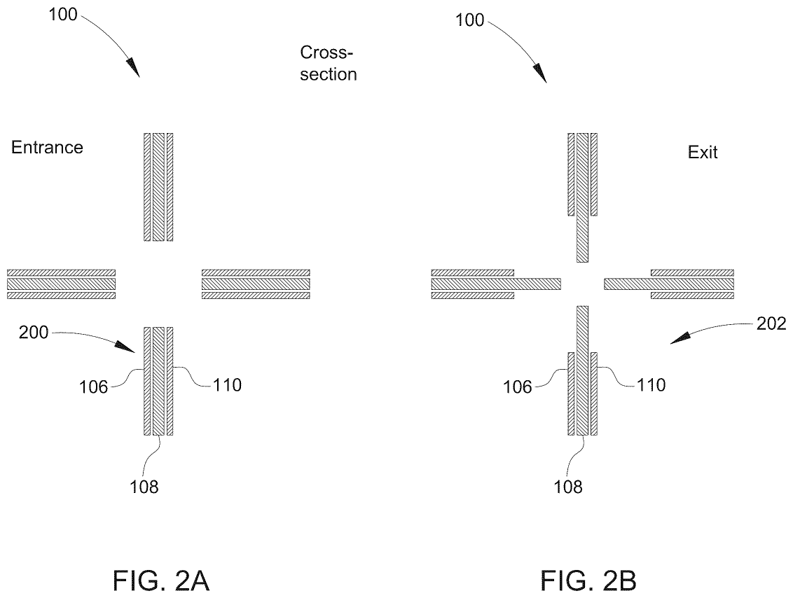

FIG. 2A illustrates a cross-section of the multipole ion guide 100 at the entrance, in accordance with an example of the present disclosure. FIG. 2B illustrates a cross-section of the multipole ion guide 100 at the exit, in accordance with an example of the present disclosure.

Referring to FIGS. 2A and 2B, the blade electrodes that are tapered in the widthwise dimension from a larger width at the entrance 112 to a smaller width at the exit 114, thus include is larger dimension at the entrance as shown at 200 in FIG. 2A, compared to smaller dimension at the exit as shown at 202 in FIG. 2B.

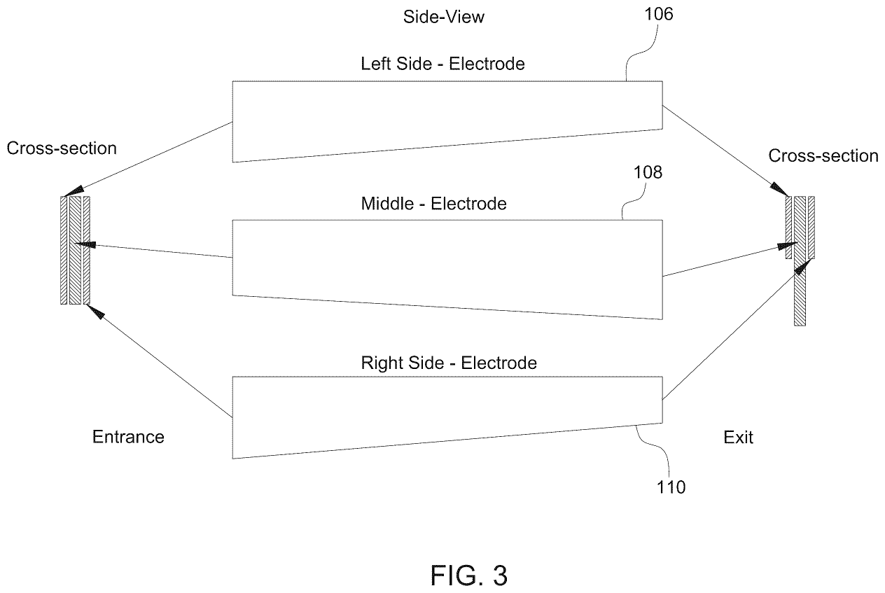

FIG. 3 illustrates a side view of the three blade electrodes of each group for the multipole ion guide 100, in accordance with an example of the present disclosure.

Referring to FIG. 3, a side view of the three blade electrodes 106, 108, and 110 of each group for the multipole ion guide 100 is shown. The top view shows the left side-electrode 106, the middle view shows the middle electrode 108, and the bottom view shows the right side-electrode 110. The tapering of the middle electrode 108 may be different from the side electrodes 106 and 110, whereas the side electrodes may be of the same shape. Each electrode may be tapered linearly or nonlinearly.

The electrical isolation between the middle electrode 108 and the side electrodes 106 and 110 in each group may be implemented, for example, by a dielectric spacer. Alternatively, the electrical isolation between the middle electrode 108 and the side electrodes 106 and 110 in each group may be implemented by replacing the side electrodes with flex circuits.

According to examples disclosed herein, the middle electrode 108 may be of different thickness compared to the side electrodes 106 and 110.

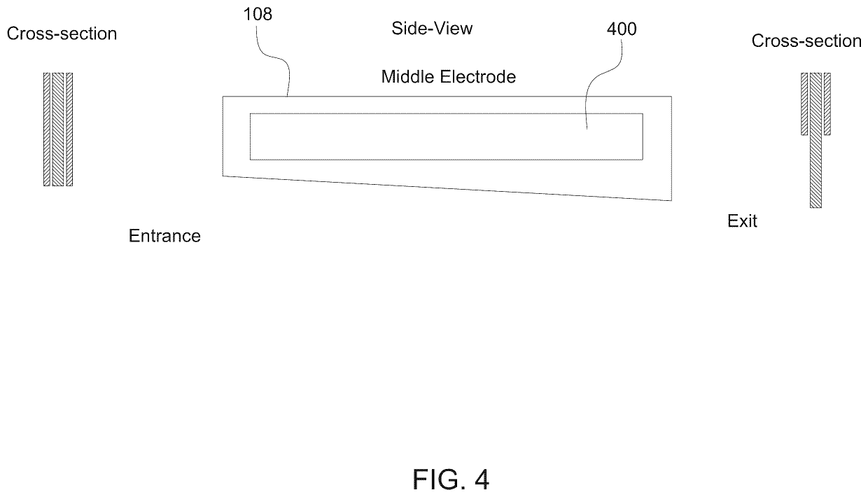

FIG. 4 illustrates a hollow middle electrode to reduce electrical capacitance to the side electrodes for the multipole ion guide 100, in accordance with an example of the present disclosure.

Referring to FIG. 4, the middle electrode 108 may be hollow as shown at 400. The hollow implementation of the middle electrode 108 may reduce electrical capacitance to the side electrodes 106 and 110.

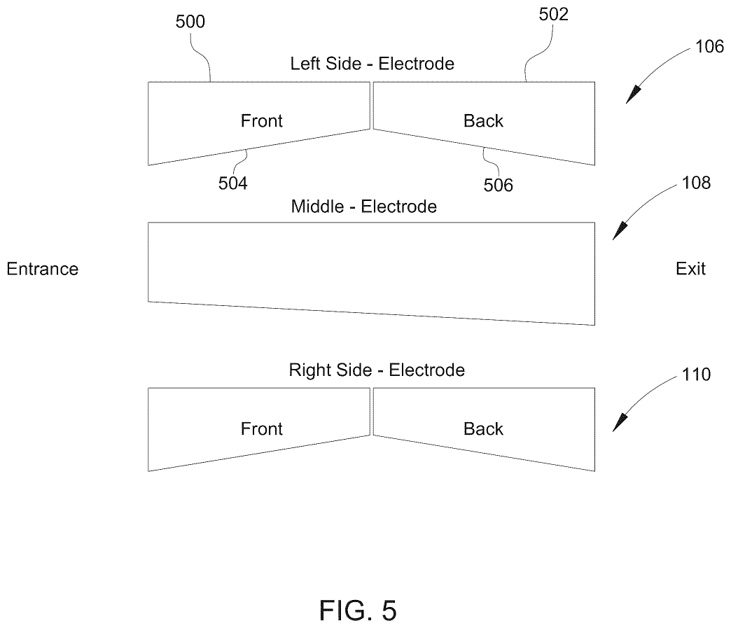

FIG. 5 illustrates how the side electrodes may be divided into two sections in an axial dimension and tapered in opposite directions in the axial dimension for the multipole ion guide 100, in accordance with an example of the present disclosure.

Referring to FIG. 5, the side electrodes 106 and 110 may be further divided into two sections (e.g., a front section 500, and a back section 502) in the axial dimension. These two sections 500 and 502 may be tapered as shown at 504 and 506 in opposite directions in the axial dimension.

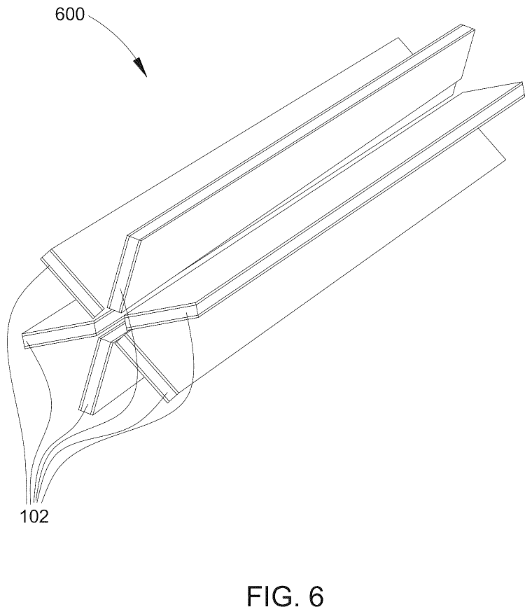

FIG. 6 illustrates a hexapole configuration for the multipole ion guide 100, in accordance with an example of the present disclosure.

As disclosed herein with respect to FIG. 1, a number of the electrode groups 102 may be greater than or equal to four. In this regard, FIG. 6 illustrates a multipole ion guide 600 including six electrode groups 102.

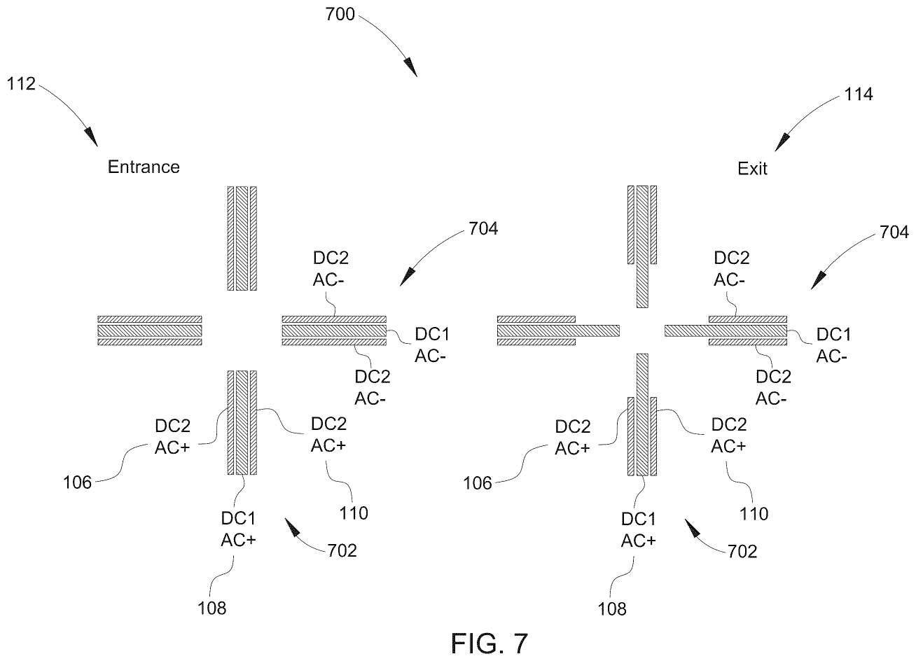

FIG. 7 illustrates an operational scheme 700 where a middle electrode in each group is supplied with a different DC voltage than side electrodes for the multipole ion guide 100, in accordance with an example of the present disclosure.

Referring to FIG. 7, the middle electrode 108 in each electrode group 102 may be supplied with a different DC voltage than the side electrodes 106 and 110. For example, as shown at 702 and 704, the middle electrode 108 in each electrode group 102 may be supplied with a different DC voltage (e.g., DC1) than the side electrodes 106 and 110 (e.g., DC2). As the middle electrode 108 is tapered differently than the side electrodes 106 and 110, a DC potential gradient may be established along the axis 104 of the multipole ion guide 100 to advance ions.

In the example of FIG. 7, as shown at 702, all three electrodes 106, 108, and 110 in each group 102 may be supplied with an AC voltage of the same frequency, amplitude, and phase (e.g., AC+ as shown in FIG. 7). As shown at 704, the AC voltages on adjacent groups may be of the same frequency and amplitude, but opposite phases (e.g., AC− as shown in FIG. 7). Thus, a 2D multipole field may be generated on the transverse plane orthogonal to the axis 104 to confine ions. Due to the aforementioned tapering features, the effective width and inscribed radius may gradually decrease along the axis 104 from the entrance 112 to the exit 114, which provides a larger acceptance at the entrance 112 and a stronger focusing power at the exit 114.

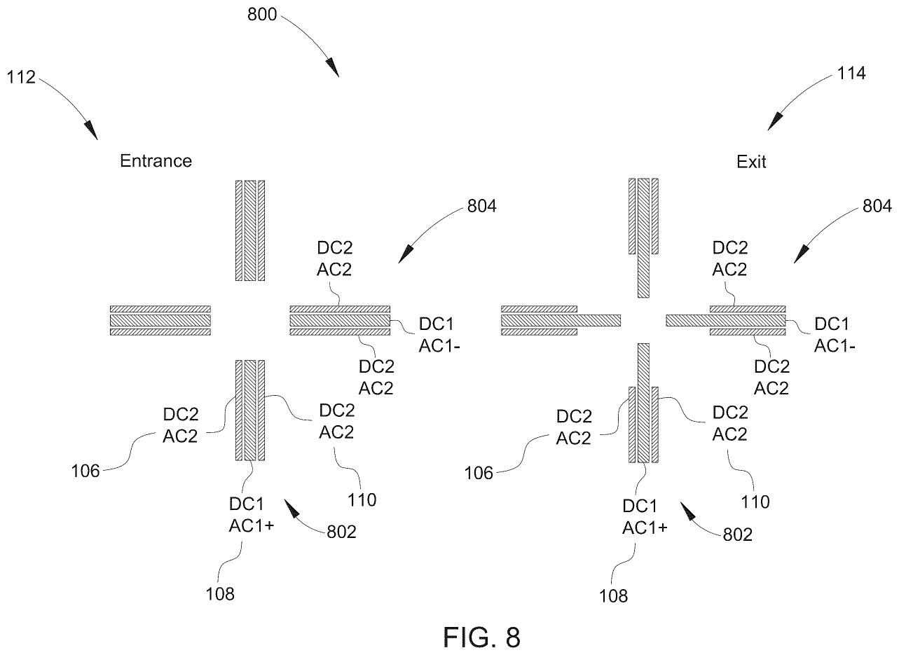

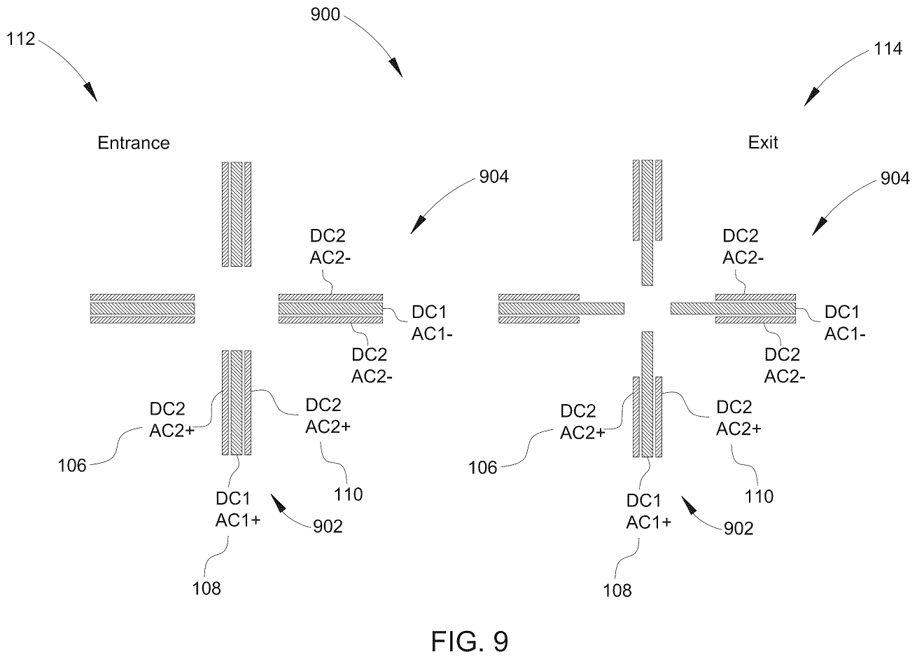

FIG. 8 illustrates an operational scheme 800 where AC voltages on side electrodes of adjacent groups are of a same frequency and amplitude, and of same phases for the multipole ion guide 100, in accordance with an example of the present disclosure. FIG. 9 illustrates an operational scheme 900 where AC voltages on side electrodes of adjacent groups are of a same frequency and amplitude, and of opposite phases for the multipole ion guide 100, in accordance with an example of the present disclosure.

Referring to FIGS. 8 and 9, the middle electrode 108 in each group is supplied with a different DC voltage (e.g., DC1) than the side electrodes (e.g., DC2). Thus, a DC potential gradient may be established along the axis 104 of the multipole ion guide 100 as described with reference to FIG. 7.

The middle electrode 108 of each group may be supplied with a different AC voltage (e.g., AC1) than the side electrodes 106 and 110 (e.g., AC2) of the same group, i.e., different amplitude and frequency. The side electrodes 106 and 110 of each group may be supplied with the same AC voltage (e.g., AC2), e.g., the same voltage amplitude, frequency, and phase. The AC voltages on the middle electrode 108 of the adjacent groups may be of the same frequency and amplitude but opposite phases (e.g., AC1+ and AC1−). The AC voltages on the side electrodes (e.g., AC2) of the adjacent groups may be of the same frequency and amplitude, and same (e.g., FIG. 8; e.g., AC2) or opposite (e.g., FIG. 9; e.g., AC2+, AC2−) phases. Due to the aforementioned tapering features, an additional multipole field of lower frequency and/or higher orders may be generated at the entrance 112, and consequently further increase the acceptance at the entrance 112.

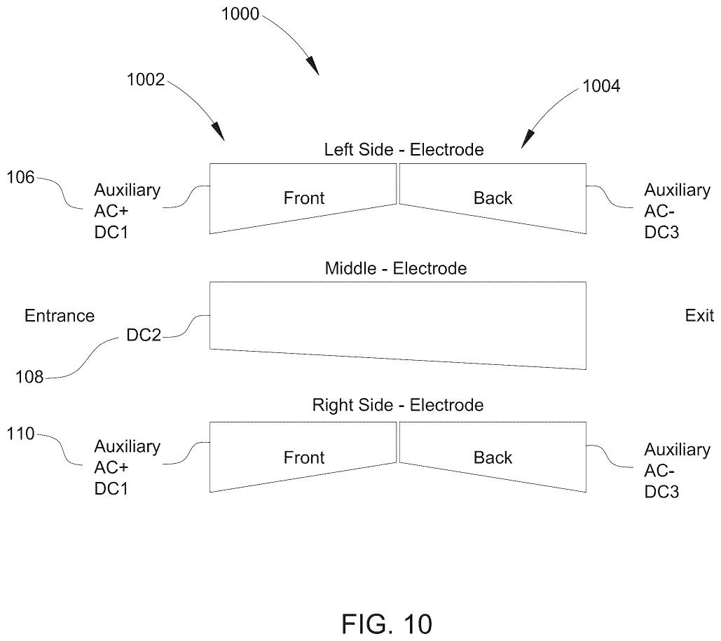

FIG. 10 illustrates an operational scheme 1000 where AC voltages are supplied to middle and side electrodes for the operational schemes of FIGS. 7-9, for the multipole ion guide 100, in accordance with an example of the present disclosure.

Referring to FIG. 10, AC voltages may be supplied to the middle (e.g., 108) and side electrodes (e.g., 106 and 110) according to the operational schemes of FIGS. 7-9. In this regard, the side electrodes 106 and 110 of front-section 1002 and back-section 1004 may be supplied with an auxiliary AC voltage, with opposite phases (e.g., AC+, AC−) between these two sections. Thus, an axial pseudo-potential well may be created to form an ion trap in the longitudinal dimension.

Further, three DC voltages (e.g., DC1, DC2, and DC3) may be supplied to the middle (e.g., 108) and side electrodes (e.g., 106 and 110) of front-section 1002 and back-section 1004. Consequently, the ions may be trapped and selectively ejected based on the mass-to-charge ratio in the axial dimension based on the aforementioned combination of DC and AC voltages.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A multipole ion guide comprising:
a plurality of electrode groups that are arranged circumferentially around an axis of the multipole ion guide,
wherein at least one electrode group of the plurality of electrode groups includes at least three electrodes that are disposed in a side-by-side configuration.

2. The multipole ion guide according to claim 1, wherein the plurality of electrode groups includes an even number of electrode groups.

3. The multipole ion guide according to claim 1, wherein the at least three electrodes includes blade electrodes that are electrically isolated from each other.

4. The multipole ion guide according to claim 3, wherein the at least three electrodes are electrically isolated from each other by at least one of dielectric spacing or a flex circuit.

5. The multipole ion guide according to claim 1,
wherein the at least three electrodes are tapered in a widthwise dimension to include a larger width at an entrance of the multipole ion guide to a smaller width at an exit of the multipole ion guide.

6. The multipole ion guide according to claim 1,
wherein side electrodes of the at least three electrodes are tapered in a widthwise dimension to include a larger width at an entrance of the multipole ion guide to a smaller width at an exit of the multipole ion guide.

7. The multipole ion guide according to claim 6,
wherein an inner electrode of the at least three electrodes is tapered in a widthwise dimension to include a smaller width at the entrance of the multipole ion guide to a larger width at the exit of the multipole ion guide.

8. The multipole ion guide according to claim 1,
wherein the at least three electrodes are linearly tapered in a widthwise dimension.

9. The multipole ion guide according to claim 1,
wherein a thickness of a middle electrode of the at least three electrodes is different from a thickness of side electrodes of the at least three electrodes.

10. The multipole ion guide according to claim 1,
wherein a middle electrode of the at least three electrodes includes a hollow configuration compared to side electrodes of the at least three electrodes.

11. The multipole ion guide according to claim 1,
wherein side electrodes of the at least three electrodes are divided in two sections along an axial dimension of the multipole ion guide, and
wherein each section of the two sections is tapered in opposite directions along the axial dimension for the multipole ion guide.

12. A method of operating the multipole ion guide of claim 1, the method comprising:
applying a different direct current (DC) voltage to a middle electrode of the at least three electrodes compared to side electrodes of the at least three electrodes.

13. A method of operating the multipole ion guide of claim 1, the method comprising:
applying a different alternating current (AC) voltage phase to an electrode group of the plurality of electrode groups compared to an adjacent electrode group of the plurality of electrode groups.

14. A method of operating the multipole ion guide of claim 1, the method comprising:
applying a different alternating current (AC) voltage to a middle electrode of the at least three electrodes compared to side electrodes of the at least three electrodes.

15. A method of operating the multipole ion guide of claim 1, the method comprising:
applying a different alternating current (AC) voltage phase to a front section of a side electrode of the at least three electrodes compared to a back section of the side electrode of the at least three electrodes.

16. A method of operating the multipole ion guide of claim 1, the method comprising:
applying a different direct current (DC) voltage to a front section of a side electrode of the at least three electrodes compared to a back section of the side electrode of the at least three electrode; and
applying a further different DC voltage to a middle electrode of the at least three electrodes.

17. A multipole ion guide comprising:
a plurality of electrode groups that are arranged circumferentially around an axis of the multipole ion guide,
wherein each electrode group of the plurality of electrode groups includes at least three electrodes that are disposed in a side-by-side configuration.

18. A multipole ion guide comprising:
a plurality of electrode groups that are arranged around an axis of the multipole ion guide,
wherein each electrode group of the plurality of electrode groups includes at least three electrodes that are disposed in a side-by-side configuration.

19. The multipole ion guide according to claim 18,
wherein the at least three electrodes are tapered in a widthwise dimension to include a larger width at an entrance of the multipole ion guide to a smaller width at an exit of the multipole ion guide.

20. The multipole ion guide according to claim 18,
wherein a thickness of a middle electrode of the at least three electrodes is different from a thickness of side electrodes of the at least three electrodes.
